(19) United States
(12) Patent Application Publication
(10) Pub. No.: US 2013/0268868 A1
(43) Pub. Date: Oct. 10, 2013

(54) Embedded Communication Facility for Collaborative Business Networks

(71) Applicants: Michael Stollberg, Dresden (DE); Stephan Heyne, Dresden (DE); René Fleischhauer, Dresden (DE)

(72) Inventors: Michael Stollberg, Dresden (DE); Stephan Heyne, Dresden (DE); René Fleischhauer, Dresden (DE)

(73) Assignee: SAP AG, Walldorf (DE)

(21) Appl. No.: 13/443,159

(22) Filed: Apr. 10, 2012

(51) Int. Cl. G06F 15/16; G06F 3/01

(52) U.S. Cl. 715/753; 709/205

(57) ABSTRACT

A communication facility embedded in a personalized workspace of collaborative platform for business network participants, facilitates communication, information exchange, and coordination in both human and automated interactions. The embedded facility may comprise one or more of the following. An event handler initiates information exchange between business partners, manually by user input or automatically by event(s) triggered in connected business systems. An artifact generator creates messages to be exchanged, either by instantiating a pre-defined message type or by analysis of event(s) and creation of a respective message. A transfer element is configured to transfer the generated communication artifact via one or more communication channels supported by sending and receiving participants. A notification element updates a party receiving the communication artifact, by updating the graphical workspace of the human end-users, by updating integrated business systems with respect to the received communication artifact, or by doing both.

### BACKGROUND

Unless otherwise indicated herein, the approaches described in this section are not prior art to the claims in this application and are not admitted to be prior art by inclusion in this section.

In the industrial praxis, communication between partners working in collaborative business networks is in general conducted manually using various communication systems. Examples of such communications systems include but are not limited to email, instant messaging, texting, voice (phone), and facsimile.

As a result, manual effort is needed to extract information to be communicated between business partners from an internal business system in order to achieve a common or shared business goal. This is because the discrete organization/individual actors in such collaborative business networks employ different, non-integrated business systems. Such lack of integration gives rise to the need for manual, time consuming, and error-prone processes for collaboration among business partners. This hampers the business efficiency and effectiveness of each partner involved in collaborative business networks.

The present disclosure addresses this and other issues with embodiments of systems and methods providing an embedded communication facility for collaborative business networks.

### SUMMARY

Embodiments relate to systems and methods providing a communication facility embedded in a personalized workspace of participants in a business network. The embedded communication facility allows easy-to-use, real-time communication, information exchange, and coordination with other participants in a business network, for both human and automated interactions involving integrated business systems.

Embodiments may comprise one or more of the following elements. A communication event handler initiates information exchange between business partners, manually by user input or automatically by event(s) triggered in connected business systems. A communication artifact generator creates messages to be exchanged, either by instantiating a pre-defined message type or by analysis of event(s) and creation of a respective message. A multi-channel transfer element is configured to transfer the generated communication artifact via one or more communication channels supported by sending and receiving participants. A notification element may rapidly (e.g. in real time or near-real time) update a party receiving the communication artifact, by updating the graphical workspace of the human end-users, by updating integrated business systems with respect to the received communication artifact, or by doing both.

The embedded communication facility can be implemented as a generic software infrastructure, serving as a central building block of a form of collaboration platforms allowing business partners to easily exchange information and coordinate their activities along with Software as a System (SaaS) solutions and the integration to individual business systems.

An embodiment of a computer-implemented method comprises causing an event handler to initiate an information exchange between a first business partner and a second business partner on a connected business system. In response to the event handler, an artifact generator is caused to create a communication artifact. A transfer element is caused to transfer the communication artifact from the first business partner to a central component via a first communication channel. The transfer element is caused to transfer the communication artifact from the central component to the second business partner. In response to transfer of the communication artifact to the second business partner, a notification element is caused to update the second business partner regarding the communication artifact.

An embodiment of a non-transitory computer readable storage medium embodies a computer program for performing a method. Said method comprises causing an event handler to initiate an information exchange between a first business partner and a second business partner on a connected business system. In response to the event handler, the method further comprises causing an artifact generator to create a communication artifact. A transfer element is caused to transfer the communication artifact from the first business partner to a central component via a first communication channel. The transfer element is caused to transfer the communication artifact from the central component to the second business partner. In response to transfer of the communication artifact to the second business partner, the method comprises causing a notification element to update the second business partner regarding the communication artifact.

An embodiment of a computer system comprises one or more processors and a software program stored in a non-transitory computer readable storage medium and executable on said computer system. The software program is configured to cause an event handler to initiate an information exchange between a first business partner and a second business partner on a connected business system. In response to the event handler, the software program is configured to cause an artifact generator to create a communication artifact. The software program is configured to cause a transfer element to transfer the communication artifact from the first business partner to a central component via a first communication channel. The software program is configured to cause the transfer element to transfer the communication artifact from the central component to the second business partner. In response to transfer of the communication artifact to the second business partner, the software program is configured to cause a notification element to update the second business partner regarding the communication artifact.

Certain embodiments further comprise causing the transfer element to also transfer the communication artifact from the central component to a third business partner.

According to some embodiments, the transfer element is configured to transfer the communication artifact from the central component to the second business partner, via the first communication channel or via a second communication channel different from the first communication channel.

In particular embodiments, the event handler is configured to initiate the information exchange manually from a user input, or to initiate the information exchange automatically based upon an event triggered in the connected business system.

According to particular embodiments, the artifact generator is configured to create the artifact by instantiating a pre-defined message type, or to create the artifact based upon an analysis of an event in the connected business system.

In certain embodiments, the notification element updates the second business partner by updating a graphical workspace of the second business partner, and/or by updating the connected business system with respect to the communication artifact.

In some embodiments, the notification element updates the second business partner in real time.

The following detailed description and accompanying drawings provide a better understanding of the nature and advantages of various embodiments.

### BRIEF DESCRIPTION OF THE DRAWINGS

FIG. 1 shows a generic depiction of an embedded communications facility according to an embodiment.

FIG. 2 is a simplified view of a collaboration platform incorporating an embedded communications facility according to an embodiment.

FIG. 3 illustrates one specific example of an embodiment of a communications facility.

FIG. 4 shows a simplified view of a front-end of a collaboration platform for business networks according to an embodiment

FIG. 5 illustrates hardware of a special purpose computing machine which may be configured to implement notification viewing in accordance with particular embodiments.

FIG. 6 illustrates an example of a computer system.

FIG. 7 is a simplified flow diagram illustrating a method according to an embodiment.

### DETAILED DESCRIPTION

The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, examples and specific details are set forth in order to provide a thorough understanding of various embodiments of the present invention. It will be evident, however, to one skilled in the art that the present invention as defined by the claims may include some or all of the features in these examples alone or in combination with other features described below, and may further include modifications and equivalents of the features and concepts described herein.

Currently, few business networks employ efficient collaboration facilities between partners. Some examples may be found in well-established businesses (e.g. in the manufacturing, automotive, logistics domain), where a dominant player defines the collaboration system to which all others must commit to participate in the business network. This results in closed business networks with high entrance barriers for new partners, particularly small and medium enterprises (SMEs), limiting flexibility for adapting to changed business processes.

Accordingly, embodiments relate to systems and methods providing communication facilities embedded into the personalized workspace of each participant in a collaborative business network. The facility is easy-to-use and allows real-time communication, information exchange, and coordination with the other participants in a collaborative business network. Such interaction may take place on a personal level manually between individual users, or may occur as an automated interaction involving integrated business systems.

In general, it may not be relevant for sender or receiver if the other parties process interactions manually or automated. A sender can create messages manually or in an automated fashion, without predefining how the receiver will handle the message.

Embodiments can be implemented in form of a generic software infrastructure, which may serve as a building block of a form of collaboration platform where business partners can easily exchange information and coordinate their activities along with SaaS solutions and the integration to individual business systems.

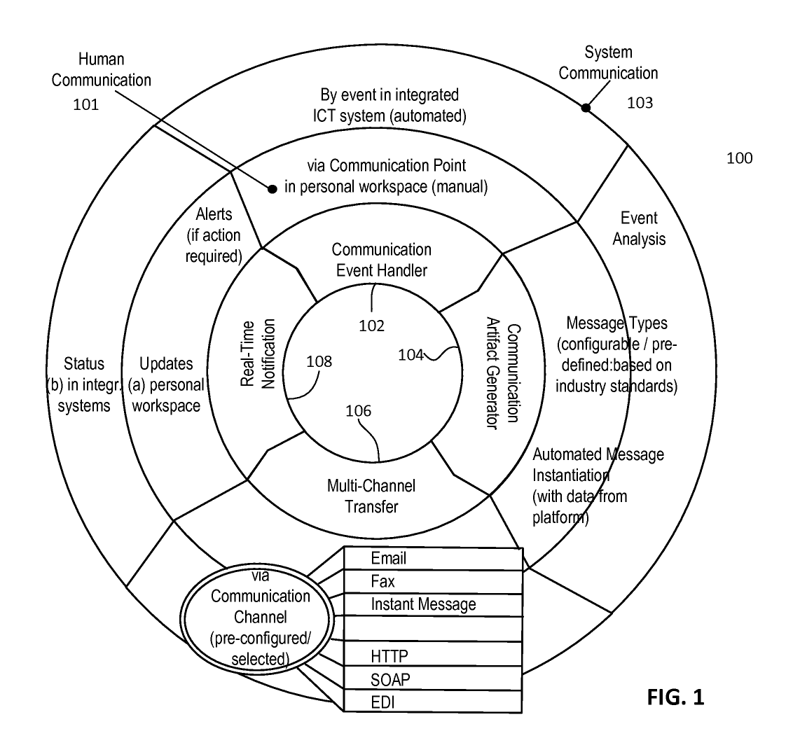

As described in further detail below, embodiments of embedded communication facilities may comprise one or more of the following four technological elements. These elements are shown schematically in the generic depiction of an embedded communications facility 100 of FIG. 1.

Specifically, a communication Event Handler 102 is concerned with initiating the information exchange between two or more business partners. Such information exchange may be initiated by manual inputs where a human user triggers the information exchange via communication points within the graphical workspace. Alternatively, such information exchange may be initiated by events occurring in connected business systems that trigger an information exchange to one or more participants;

The communications facility 100 of FIG. 1 further comprises a Communication Artifact Generator 104 that creates messages to be exchanged between participants. The message may be generated by instantiating a pre-defined message type based on a relevant industry standard (e.g. EDIFACT™) with data already present in the collaboration platform. Alternatively, the message may be generated by analyzing event(s) and automatically creating a respective message in response thereto. Messages may be notifications which require no actions of the receiver, or requests which may require actions of the receiver.

Communications facility 100 of FIG. 1 further comprises a Multi-Channel Transfer element 106. This element 106 transfers the generated communication artifact via at least one or more communication channels supported by the sending and receiving participants respectively. Participants can freely pre-configure which communication channels are used for receiving and internally forwarding messages depending, on the single message types. Thus in an example, a status request may be sent via email, delay information may be sent via SMS, and all other messages may be sent via EDIFACT™. Examples of types of communications channels include but are not limited to an EDIFACT™ message, a simple object access protocol (SOAP)/HTTP message, an email, a SMS text message, or a fax.

The communications facility 100 further comprises a Notification element 108 that rapidly (e.g. in real-time) updates the receivers of the communication artifact. This notification may take place by updating the graphical workspace of the human end-users.

Alternatively, this notification may take place by updating the integrated business systems with respect to the received communication artifact or both. The Notification element 108 can also trigger communication events, e.g. replies to a notification, which then will be handled again by communication event handler 102.

Logically, the four elements follow each other (e.g. event→message→transfer→notification). In reality, however, an individual end-user can undertake activities in different realms simultaneously.

In the FIG. 1, middle circle 101 indicates the ability of the embedded communication facility to support human interaction—that is, for example information exchange between two persons where each conducts a certain action within the overall business process. Examples include creating an order, making a quotation, or confirming a payment. However, manual interaction at the sender's side does not require or exclude manual interaction at the receiver's side, and vice versa.

The outer circle 103 of FIG. 1 indicates the ability of the embedded communication facility to platform automatic interaction. Examples include communication where information and communication technology (ICT) systems are involved (e.g. automated events received when passing an RFID gate).

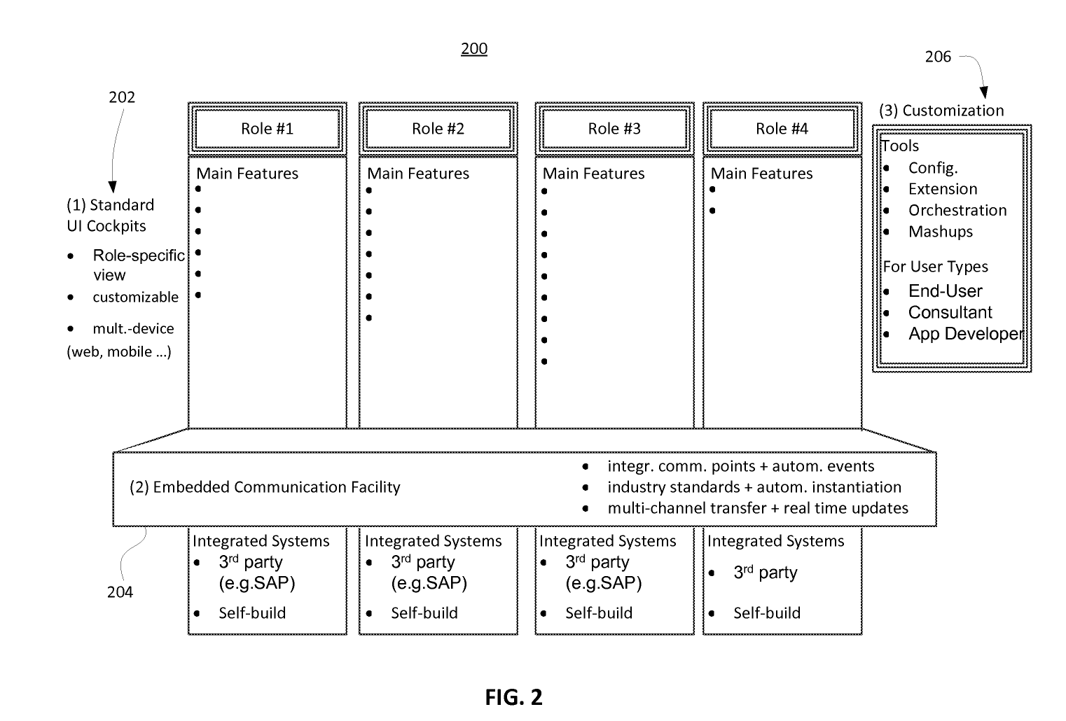

FIG. 2 is a simplified view of a collaboration platform incorporating an embedded communications facility according to an embodiment. In particular, platform 200 comprises customizable standard user interface(s) 202 (also referred to herein as “cockpits”), an embedded communication facility 204, and a customization facility 206.

In particular, a customizable standard user interface 202 is available for each of the roles played by various participants in the collaboration platform. Some roles of possible participants in a scenario involving the transport and logistics domain, are described below. The role of the user may dictate the nature and functionality of the interface of the user with the embedded communications facility. The UI cockpit may allow communication with multiple types of devices, including but not limited to internet sites, mobile devices, etc. Standard user interfaces may be built using technology frameworks which already include support for integration of the embedded communication facility 204 and for the customization facilities 206. Those frameworks could be built-in to existing user interface technology frameworks.

As mentioned above, the embedded communication facility 204 facilitates the easy-to-use and real-time communication, information exchange, and coordination between the business partners via their respective standard UI cockpits and the business systems that each one has connected to the platform.

The customization facilities 206 allow end-users as well as other IT-roles, to personalize, extend, and combine the standard UI cockpits, as well as SaaS solutions provided along with the collaboration platform for individual business needs. An example would be to add a new communication point to an existing UI cockpit and binding an existing message type to it. Tools available in the customization facility can allow configuration, extension, orchestration, and the creation of mashups. Customization for various user types is available, including end-users, consultants, and application developers.

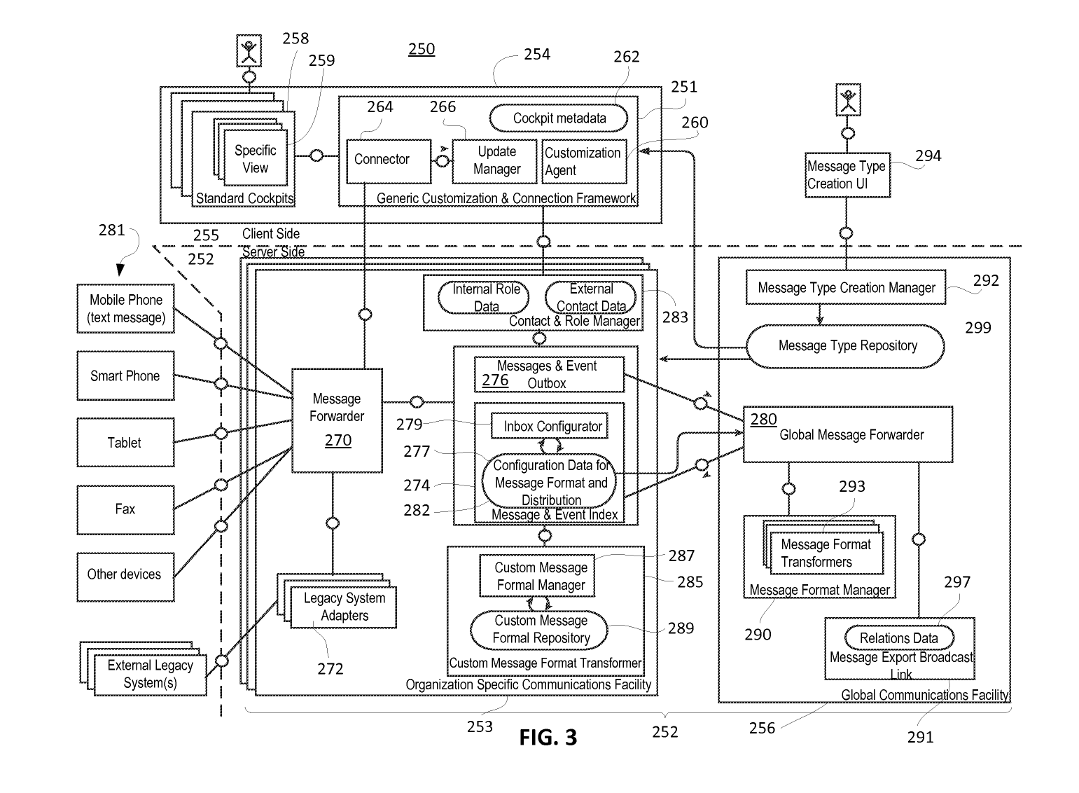

FIG. 3 is a view of an architecture of one particular embodiment of a collaboration platform, that is implemented in a client-server configuration. The collaboration platform 250 comprises an embedded communications facility 252 and a user interface layer 254.

The embedded communications facility 252 includes a central component comprising a global communication facility 256 and an organization-specific communication facility 253. Details of this particular embodiment of the embedded communications facility are described further below.

The user-interface layer 254 resides on the client side 255 on top of the organization-specific communication facility. The user-interface layer comprises standard cockpits 258 which are the UIs for clients within an organization. One cockpit can comprise several specific views.

The user-interface layer 254 further comprises a generic customization and connection framework 251. This framework allows standard cockpits and specific views to be customized by adding buttons (representing communication points) for triggering the sending of certain messages. This framework 251 could be integrated into existing frameworks used to build user interfaces, facilitating integration of the embedded communication facility.

The generic customization and connection framework 251 allows tailoring of the standard cockpit interfaces, and includes a customization agent 260 that is the technical component for implementing the functionality to customize views and cockpits. The customization agent knows about different message types, because a message type is chosen for binding it to new buttons. As indicated the customization agent may reference the cockpit metadata storage 262.

The generic customization and connection framework 251 further comprises a connector 264. The connector is responsible for exchanging messages in a bidirectional manner with the organization-specific communication facility on the server side 257. The connector utilizes the cockpit metadata storage in order to build and sent messages.

The generic customization and connection framework 251 further comprises an update manager 266. This manager receives incoming messages from the connector and uses the cockpit metadata to update appropriate parts of the cockpits with the given data.

The embedded communications facility 252 is now described in detail. The organization-specific communication facility 253 is hosted by an organization, connected to the global communication facility 256 and is mainly used to customize and configure the message handling within the organization.

The organization-specific communication facility 253 includes a message forwarder component 270 responsible for forwarding messages to different components and devices. This message forwarder knows how to communicate with different kinds of devices, the legacy system adapters 272, message/event inbox 274 and outbox 276, as well as the connector 264. The message forwarder accepts messages from the connector 264, the message/event inbox 274, external devices 281 and legacy system adapters. That means that it works in a bidirectional manner. Additionally, message forwarder forwards message to the connector 264, the message/event outbox 276, external devices 281 and legacy system adapters.

The message and event outbox 276 receives messages from the message forwarder and sends them to the global message forwarder 280 of the global communication facility 256. The outbox may use a custom message format transformer 277 to accomplish this.

The message and event inbox 274 is configured to receive messages from the global message forwarder 280. Received messages will already be in the appropriate message format, so that a transformation is needed and performed if organization-specific custom message formats are defined and used with the received messages. The inbox 270 can be configured using the inbox configurator 279 to distribute messages to one or more receivers over one or more channels 281 (e.g. email, text message or fax). Such configuration data can be stored in the storage configuration data for message format and distribution component 282.

The organization-specific communication facility 253 also includes a contact and role manager 283. This component is used to store and manage organization-internal role definitions and external contact data (mainly to assign receivers for outgoing messages). New external contact data can (among others) come from the Inbox.

The organization-specific communication facility 253 also includes a custom message format transformer 285. In particular, within an organization unofficial message formats can be defined, but those need to be transformed to an official message format before they can be sent to the global message forwarder or can be received from it. Accordingly the transformer 285 can be used by the inbox and the outbox to either encode an official message format to a custom format, or to decode them again. One example of a custom message format would be a special formatted text message.

The custom message format transformer includes a custom message format manager 287 that is used to define and edit custom message formats. Custom message formats can be stored in the custom message format repository 289.

Finally, the organization-specific communication facility 253 may also include one or more legacy system adapters 272. These are used to connect legacy systems to the organization-specific communication facility, with each legacy system utilizing its own adapter. The adapter(s) can receive messages and import the data to the legacy system. The adapter(s) can also send messages triggered by the legacy system.

As previously mentioned, the embedded communication facility 252 of the embodiment of FIG. 3 also comprises the global communication facility 256. The global message forwarder 280 plays a central role, receiving messages of organization-specific message and event outboxes.

For example, the global message forwarder reads message format data of receivers of a message, and triggers the transformation of a received message into necessary message formats in order to ensure that each transformation is only processed once. It then sends those to the receivers (one inbox can accept the same message in different formats in order to forward it internally by text message and to the update manager 266, for example). In a productive environment, it may be desirable to transform messages in the organization-specific communication facility 253 instead of the global communication facility 256. This can avoid the global communication facility becoming bottleneck of the whole communication facility 252.

The global message forwarder can use the message format manager 290 to transform messages from one message format into another, if necessary. The global message forwarder can additionally send messages to the message export and broadcast unit 291, which may be used by tools which provide a global view on the data for example.

The global communication facility 256 further comprises a message type creation manager 292. This is used as a single point of access for creation of new message types (e.g. a new kind of status update or a new kind of information request).

The message type creation manager 292 is in communication with message type repository 299 that includes a global registry for already existing message types. Manager 292 compares new message types with existing types, and blocks the creation if a similar type already exists. That is done because otherwise it would be difficult to automatically handle many similar message types using Legacy System Adapters.

In this particular embodiment, the message type creation manager 292 has its own user interface—the message type creation user interface 294.

As described above the message format manager 290 is used to transform messages between format types. For each variety of such format-to-format transformation, a new message format transformer 293 may be implemented.

One possible benefit of handling all messages using a global component (global message forwarder 280), is that the information can directly be broadcast to all relevant parties—even to the ones which are not receivers of the actual message. Accordingly, the message export and broadcast unit 295 can be used to forward (broadcast) the message also to other interested parties. In this embodiment, a storage unit 297 of relations data is present.

In certain embodiments messages may not be sent directly to receivers, but instead may be sent indirectly by referring to a shipment (e.g. in a transport and logistics domain scenario), with participants receiving notifications and events regarding shipments they are registered for. This would facilitate sender efforts by avoiding having to select specific receivers of a message.

The message export and broadcast unit can also be used to export the data to a global storage or for viewing. An example in the transport and logistics domain, is display of a progress page showing current status of a delivery.

According to various embodiments, a collaboration platform may be open to an interested party, along with customization tools for personalization of individual workspaces and with barriers for adaption, therewith overcoming deficiencies of collaboration facilities arising within closed and inflexible business networks.

A collaboration platform, including an embedded communication facility, can be beneficially applied in various domains where business partners (e.g. organizations, individuals) can easily exchange information and coordinate their activities within collaborative business networks. Examples of such domains include but are not limited to:
supply chains in various industries (e.g. production, manufacturing, automotive)
public/social/governmental domains;
inter-organizational business processes (e.g. auditing, contract establishment);
intra-organizational work in distributed teams (e.g. collaborative software engineering, decision making, etc.); and
transport and logistics for international freight and passenger transport.

In order to illustrate certain aspects of some embodiments, the following example focuses upon one application within the transport and logistics domain.

### Example

One specific example of a collaboration platform may be taken from the transport and logistics domain. In particular, a shipper seeks to ship goods to a customer located abroad.

For this, the shipper contracts a freight forwarder to organize the transport. The freight forwarder in turn contracts with several carriers to conduct the transport. Specifically, a land carrier picks up the goods at the shipper's venue. An air carrier transports the goods by plane to an airport near the customer plane.

In order to collaborate to successfully transport the product from place of origin to the place of destination, the partners mentioned above need to exchange information. In particular the shipper needs to tell the forwarder, transport-relevant information for the product that is to be shipped (e.g. origin, destination, arrival time, size type, weight, etc. . . . ). The forwarder in turn needs to communicate relevant information to each of the invited carriers.

Moreover during the execution of the transport, each of the participants may seek to obtain status updates, especially if something goes wrong and re-planning is needed. Still other entities may be involved, including government agencies responsible for export control and import control.

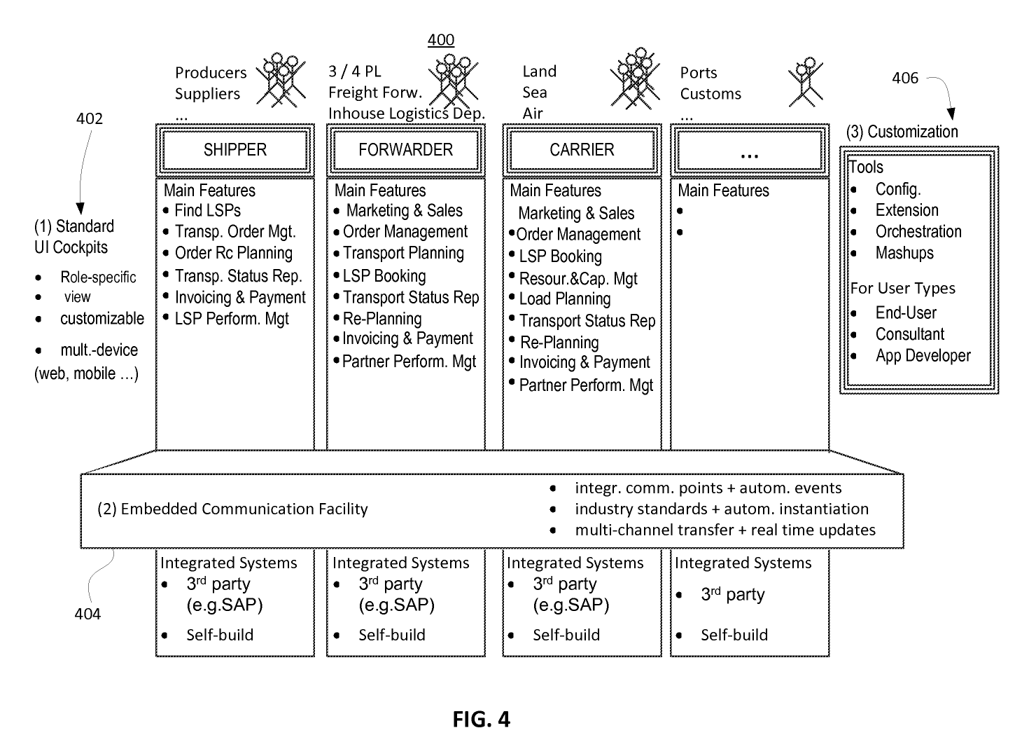

Accordingly, FIG. 4 shows a simplified view of a front-end of collaboration platform for business networks according to an embodiment. Again, the platform front-end 400 comprises three main elements: the personalized user interface cockpit 402, the embedded communication facility 404, and the customization facility 406.

Operation of various elements of the embedded communications facility in this example is now described.

Communication Event Handler

Under certain circumstances, this element can be manually triggered to initiate communication. Initially, the shipper needs to create a transport order (i.e. the order for the forwarder to organize the transport). For this the shipper goes into the ‘my transport orders’ overview within his personalized standard UI cockpit, and clicks on ‘create new transport order’.

By this, a new communication is triggered. This communication is then further processed as follows.

The entry point for triggering a new communication within the standard UI cockpits is referred to herein as a ‘communication point’. Such communication points can be defined anywhere on the standard UI cockpit, and can (but need not be) associated with a pre-defined message type.

Accordingly, human users can undertake the appropriate actions directly in the appropriate place in their personal workspace, instead of having to rely upon a separate tool. For example, a user is not required to open a separate email client and copy the information from the workspace into an email.

Alternative to human action, communications can be triggered automatically by systems. For example, as is becoming increasingly common, an RFID gate which could trigger such communications is present at the shipper's loading station for trucks.

When the goods are loaded into the truck of the land carrier for transportation to the airport, they pass the RFID gate. This event triggers a communication artifact which is then further processed as described below.

Communication Artifact Generator

Under certain circumstances, message creation may be based upon manually triggered communication. For example, in the above scenario (transport order creation by shipper): when clicking on the ‘create new transport order’ communication point, a pop-up window opens where shipper can enter the details for the transport order.

To reduce the effort required by this, the communication point is associated with a pre-defined message type: ‘Transport Order Request’. This message type is defined on the basis of an industry standard that shipper and forwarder are working with. In an example, the EDIFACT™ standard defines a message type IFTMIN that is often used to describe orders or bookings for freight transport.

In addition, the message can be instantiated with the trans-relevant data (e.g. origin, destination, arrival time, size, type, weight, . . . ). This is because such data is already available in the platform via the internal business systems that shipper has integrated into his personal standard UI cockpit. Hence, the creation of the communication artifact may be completed with minimal effort.

With this, the communication facilities ease the creation of communication artifacts (e.g. messages). In addition, the customization tools associated with the communication facility allow end-users and businesses to defined and configure their own message types, referring to public industry standards or own agreements on which information need to be exchanged. Accordingly, the platform and the communication facility remain flexible to individual business needs.

Under certain circumstances, a communications artifact may be generated for an automatically triggered communication. For the communication triggered automatically by systems, the raw data may first be analyzed in order to create a communication artifact.

In this example, assume that five pallets of goods pass the RFID gate for the land carrier truck loading. This raw data is aggregated into the communication artifact that the transport execution has started with five pallets of goods.

The intelligence for this resides in a SaaS solution that is provided within the collaboration platform. Accordingly, this communication artifact can then be described by a standard-based message type and instantiated with actual data.

Multi-Channel Transfer

After the communication artifact has been created, it needs to be transferred to the receiving party. For this the communication facility can encompass a middleware facility receiving the created communication artifact via the channel supported by the sender.

The communication artifact can then be transferred to the receiver (one or more parties) by the respectively supported communication channel(s). The communication channels supported by each participant can either be pre-defined within the personal configuration or selected on-the-fly.

For human interaction, the communication facility may support various channels such as email, fax, instant message, or the like. For automated system interaction, channels allowing communication of as a machine-readable message may be used. Examples include but are not limited to HTTP, SOAP, or electronic data interchange (EDI) messages.

In this particular example, shipper and forwarder have established an EDI infrastructure. Hence the shipper has configured in his personalized standard UI cockpit, that transport orders shall be transferred to the global communication facility 256 (FIG. 3) in the form of an EDI message of the type IFTMIN. Because, the forwarder does also support EDI and IFTMIN messages, he has configured his cockpit to receive such messages from the global communication facility 256 also in that type. Hence, the messages do not need to be transformed and are directly sent to forwarder by the global communication facility 256.

The forwarder and the trucking company do not have an integrated ICT infrastructure. However, the forwarder still sends the order in EDI message of the type IFTMIN to global communication facility 256, where it then will be transformed in the format the trucking company wants to receive (e.g. an email). As a result, forwarder sends the order for picking up the five pallets to the trucking company as an EDI message while the trucking company receives it by Email. Using that concept, every participant does not necessarily know what communication channels other parties support—it is enough that every party is configures its own system and global communication facility 256 takes care of the rest. For this, the forwarder selects ‘Email’ in his personalized standard UI cockpit as the communication channel. The communication facility generates an Email with necessary information as defined in the communication artifact, which is then sent to trucking company.

Real-Time Notification

Under certain circumstances, real-time notification and alerts may be provided in standard UI cockpits. This means that the personalized UI cockpit of the receiving party is immediately updated when a new communication artifact arrives via any transfer channel.

In this example, forwarder will receive the transport order from shipper with the ‘my orders’ list in his personalized UI cockpit, so that it is immediately present at the right place.

In addition, special alerts can be provided in case that immediate action is required. For example assume that shipper only ships three pallets of goods, instead of the five pallets that have been booked by forwarder. This will be triggered automatically if only three pallets pass the RFID gate during the truck loading by the land carrier.

This information is not only relevant for shipper and land carrier, but also for forwarder. It is especially relevant for the air carrier, because he may have to change the load plan for the plane due to the missing pallets.

To support this condition, the communication facility also immediately notifies the air carrier on the relevant communication artifact. The intelligence for determining identities of the notified parties resides in a SaaS solution provided by the platform.

With this, all stakeholders are immediately notified on any status update that occurs in the collaborative business network. This in turn allows overcoming problems of delayed or incomplete information exchange among stakeholders, as has been experienced with conventional approaches.

Under certain circumstances, the integrated business systems can be updated with the information present in communication artifacts. For example when the forwarder receives the transport order, the business system for creating the relevant transport documents can be triggered automatically, and/or the internal statistics on sales and partner management can be updated.

Such automatic activity can be realized by establishing technical interfaces for automated import and export of information. Such interfaces may substantially reduce manual effort in daily management of transport and logistics (as well as other collaborative business processes).

Embodiments as described herein may provide a basis for next generation cloud platforms substantially improving the collaboration, information exchange, and communication among the stakeholders in (inter)national logistics business networks. Examples include shippers, forwarders, agents, carriers, authorities, etc.

Embodiments may overcome business deficiencies caused by limited end-to-end visibility throughout logistics supply chains, the highly manual processes for the coordination across organizations, and closed partner networks. Building on emerging cloud and internet technologies, embodiments may facilitate the rapid and easy development of high-quality end-user applications and encompass one or more value-added services, for example for:
enhanced marketing & sales of transport and logistics services;
advanced transport planning facilities (strategic and operational);
end-to-end visibility and real-time monitoring of logistics processes;
reduction of manual effort for the planning, execution, and control of logistics processes between business partners;
integrated facilities for communication and coordination among partners;
easy integration of ICT systems (legacy and 3rd party);
enhanced business partner and network management; and
paperless transportation.

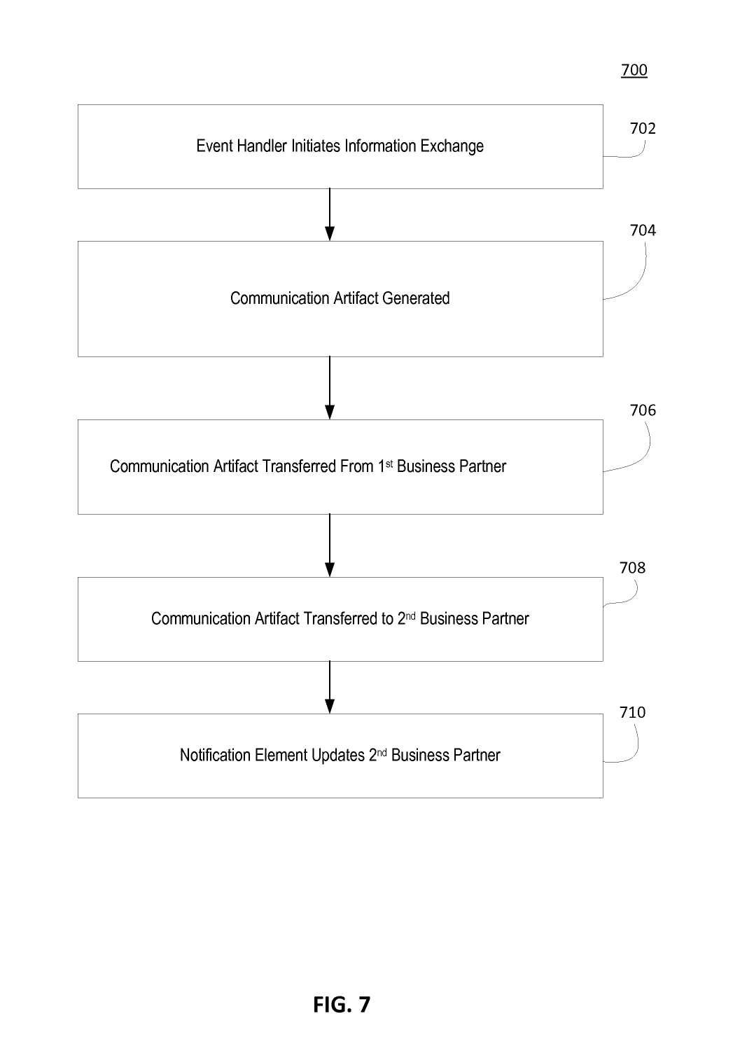

FIG. 7 is a simplified flow diagram illustrating a method 700 according to an embodiment. In a first step 702, an event handler initiates an information exchange between a first business partner and a second business partner on a connected business system. In second step 704, in response to the event handler, an artifact generator creates a communication artifact. In a third step 706, a transfer element transfers the communication artifact from the first business partner to a central component via a first communication channel. In a fourth step 708, the transfer element transfers the communication artifact from the central component to the second business partner. In a fifth step 710, in response to transfer of the communication artifact to the second business partner, a notification element updates the second business partner regarding the communication artifact.

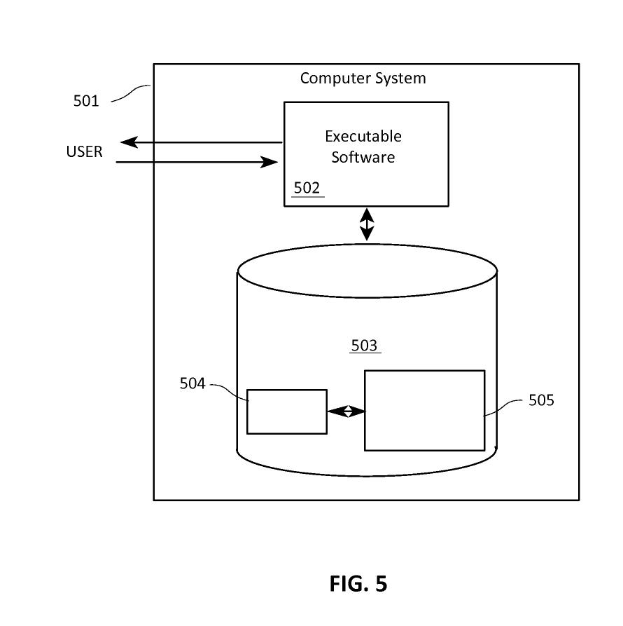

FIG. 5 illustrates hardware of a special purpose computing machine. This computing machine may be configured to implement a collaboration platform in accordance with particular embodiments.

In particular, computer system 500 comprises a processor 502 that is in electronic communication with a non-transitory computer-readable storage medium 503. This computer-readable storage medium has stored thereon code 505 corresponding to the event handler and artifact generation elements. Code 504 corresponds to the transfer and notification elements. Code may be configured to reference data stored in a database of a non-transitory computer-readable storage medium, for example as may be present local or in a remote database server.

Embodiments of may be run in conjunction with a computer system which may comprise a software server. A number of software servers together may form a cluster, or logical network of computer systems programmed with software programs that communicate with each other and work together to process requests.

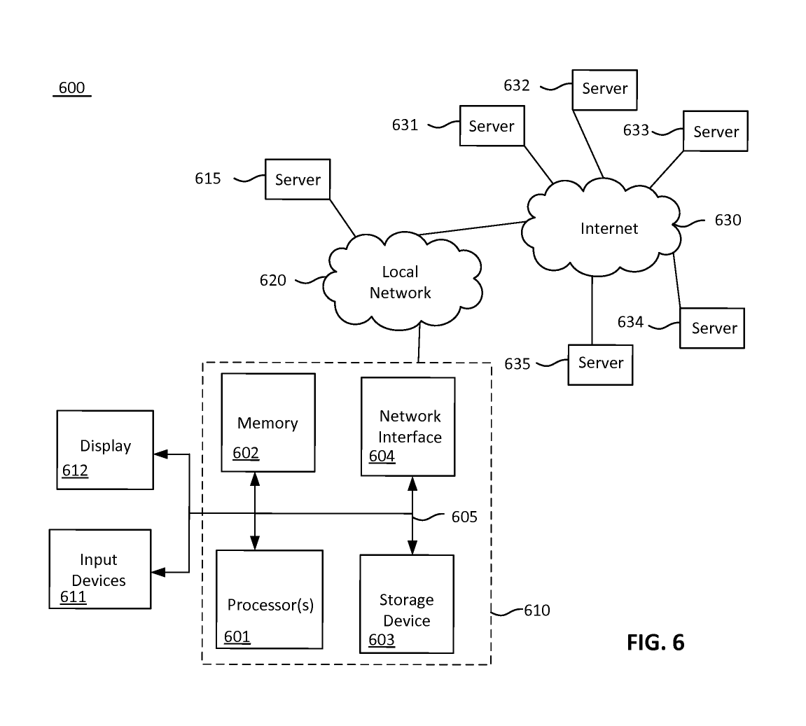

An example computer system 610 is illustrated in FIG. 6. Computer system 610 includes a bus 605 or other communication mechanism for communicating information, and a processor 601 coupled with bus 605 for processing information.

Computer system 610 also includes a memory 602 coupled to bus 605 for storing information and instructions to be executed by processor 601, including information and instructions for performing the techniques described above, for example. This memory may also be used for storing variables or other intermediate information during execution of instructions to be executed by processor 601. Possible implementations of this memory may be, but are not limited to, random access memory (RAM), read only memory (ROM), or both.

A storage device 603 is also provided for storing information and instructions. Common forms of storage devices include, for example, a hard drive, a magnetic disk, an optical disk, a CD-ROM, a DVD, a flash memory, a USB memory card, or any other medium from which a computer can read.

Storage device 603 may include source code, binary code, or software files for performing the techniques above, for example. Storage device and memory are both examples of computer readable media. The computer system generally described in FIG. 6 includes at least those attributes described in FIG. 5.

Computer system 610 may be coupled via bus 605 to a display 612, such as a cathode ray tube (CRT) or liquid crystal display (LCD), for displaying information to a computer user. An input device 611, such as a touch screen, is coupled to bus 605 for communicating information and command selections from the user to processor 601. The combination of these components allows the user to communicate with the system. In some systems, bus 605 may be divided into multiple specialized buses.

Computer system 610 also includes a network interface 604 coupled with bus 605. Network interface 604 may provide two-way data communication between computer system 610 and the local network 620. The network interface 604 may be for Broadband Wireless Access (BWA) technologies. In any such implementation, network interface 604 sends and receives electrical, electromagnetic, or optical signals that carry digital data streams representing various types of information.

Computer system 610 can send and receive information, including messages or other interface actions, through the network interface 604 across a local network 620, an Intranet, or the Internet 630. For a local network, computer system 610 may communicate with a plurality of other computer machines, such as server 615. Accordingly, computer system 610 and server computer systems represented by server 615 may form a cloud computing network, which may be programmed with processes described herein.

In an example involving the Internet, software components or services may reside on multiple different computer systems 610 or servers 631-635 across the network. The processes described above may be implemented on one or more servers, for example. A server 631 may transmit actions or messages from one component, through Internet 630, local network 620, and network interface 604 to a component on computer system 610. The software components and processes described above may be implemented on any computer system and send and/or receive information across a network, for example.

Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
causing an event handler to initiate an information exchange between a first business partner and a second business partner on a connected business system;
in response to the event handler, causing an artifact generator to create a communication artifact;
causing a transfer element to transfer the communication artifact from the first business partner to a central component via a first communication channel;
causing the transfer element to transfer the communication artifact from the central component to the second business partner; and
in response to transfer of the communication artifact to the second business partner, causing a notification element to update the second business partner regarding the communication artifact.

2. The method of claim 1 further comprising causing the transfer element to also transfer the communication artifact from the central component to a third business partner.

3. The method of claim 1 wherein the transfer element is configured to transfer the communication artifact from the central component to the second business partner, via the first communication channel or via a second communication channel different from the first communication channel.

4. The method of claim 1 wherein the event handler is configured to initiate the information exchange manually from a user input, or to initiate the information exchange automatically based upon an event triggered in the connected business system.

5. The method of claim 1 wherein the artifact generator is configured to create the artifact by instantiating a pre-defined message type, or to create the artifact based upon an analysis of an event in the connected business system.

6. The method of claim 1 wherein the notification element updates the second business partner by updating a graphical workspace of the second business partner, and/or by updating the connected business system with respect to the communication artifact.

7. The method of claim 6 wherein the notification element updates the second business partner in real time.

8. A non-transitory computer readable storage medium embodying a computer program for performing a method, said method comprising:
causing an event handler to initiate an information exchange between a first business partner and a second business partner on a connected business system;
in response to the event handler, causing an artifact generator to create a communication artifact;
causing a transfer element to transfer the communication artifact from the first business partner to a central component via a first communication channel;
causing the transfer element to transfer the communication artifact from the central component to the second business partner; and
in response to transfer of the communication artifact to the second business partner, causing a notification element to update the second business partner regarding the communication artifact.

9. The non-transitory computer readable storage medium of claim 8 wherein the method further comprises causing the transfer element to also transfer the communication artifact from the central component to a third business partner.

10. The non-transitory computer readable storage medium of claim 8 wherein the transfer element is configured to transfer the communication artifact from the central component to the second business partner, via the first communication channel or via a second communication channel different from the first communication channel.

11. The non-transitory computer readable storage medium of claim 8 wherein the event handler is configured to initiate the information exchange manually from a user input, or to initiate the information exchange automatically based upon an event triggered in the connected business system.

12. The non-transitory computer readable storage medium of claim 8 wherein the artifact generator is configured to create the artifact by instantiating a pre-defined message type, or to create the artifact based upon an analysis of an event in the connected business system.

13. The non-transitory computer readable storage medium of claim 8 wherein the notification element updates the second business partner by updating a graphical workspace of the second business partner, and/or by updating the connected business system with respect to the communication artifact.

14. The non-transitory computer readable storage medium of claim 13 wherein the notification element updates the second business partner in real time.

15. A computer system comprising:
one or more processors;
a software program stored in a non-transitory computer readable storage medium and executable on said computer system, the software program configured to:
cause an event handler to initiate an information exchange between a first business partner and a second business partner on a connected business system;
in response to the event handler, cause an artifact generator to create a communication artifact;
cause a transfer element to transfer the communication artifact from the first business partner to a central component via a first communication channel;
cause the transfer element to transfer the communication artifact from the central component to the second business partner; and
in response to transfer of the communication artifact to the second business partner, cause a notification element to update the second business partner regarding the communication artifact.

16. The computer system of claim 15 wherein the software program is further configured to cause the transfer element to also transfer the communication artifact from the central component to a third business partner.

17. The computer system of claim 15 wherein the software program is further configured to cause the transfer element is configured to transfer the communication artifact from the central component to the second business partner, via the first communication channel or via a second communication channel different from the first communication channel.

18. The computer system of claim 15 wherein the event handler is configured to initiate the information exchange manually from a user input, or to initiate the information exchange automatically based upon an event triggered in the connected business system.

19. The computer system of claim 15 wherein the artifact generator is configured to create the artifact by instantiating a pre-defined message type, or to create the artifact based upon an analysis of an event in the connected business system.

20. The computer system of claim 15 wherein the notification element updates the second business partner by updating a graphical workspace of the second business partner, and/or by updating the connected business system with respect to the communication artifact.
